(19) United States
(12) Patent Application Publication
(10) Pub. No.: US 2013/0125222 A1
(43) Pub. Date: May 16, 2013

(54) System and Method for Vetting Service Providers Within a Secure User Interface

(71) Applicants: James D. Pravetz, Sunnyvale, CA (US); Sunil Agrawal, Milpitas, CA (US); Andrei Sheretov, Campbell, CA (US)

(72) Inventors: James D. Pravetz, Sunnyvale, CA (US); Sunil Agrawal, Milpitas, CA (US); Andrei Sheretov, Campbell, CA (US)

(21) Appl. No.: 12/194,356

(22) Filed: Aug. 19, 2008

(51) Int. Cl. H04L 9/32; G06F 7/20; G06F 17/30; H04L 29/06

(52) U.S. Cl. 726/6; 726/7; 707/E17.014; 707/602

(57) ABSTRACT

A security component may be associated with a network-enabled application. The security component may initiate the display of an embedded region of a window drawn according to display information received from a relying party. The security component may define at least a portion of the appearance of the embedded region; the relying party may not define this portion. The security component may send the address of the relying party to a reputation service and query the reputation service about the reputation of the relying party. The reputation service may return reputation information about the relying party. The security component may display an indication of the relying party's reputation. If the reputation information indicates the relying party is reputable, the security component will allow the network-enabled application to exchange information with the relying party. Otherwise, the component may not allow the network-enabled application to exchange data with the relying party.

### BACKGROUND

Online threats have evolved over the years to be very sophisticated. An attacker has many methods available to trick a user into revealing sensitive information. For example, phishing is an attempt to acquire sensitive information by masquerading as a trustworthy entity. Online banks and payment services are common targets. Phishing is typically carried out by an email containing a link that may direct users to an authentic looking, but nevertheless non-authentic website. Once the user is at the website, he may be asked to enter sensitive information for verification purposes. When the user types in a username and password, sensitive information is compromised.

Another common threat is the man-in-the-middle attack. An attacker creates an authentic looking, but counterfeit web site (e.g., bank) and lures users to the web site. A user, thinking he is at his authentic bank web site, types in a username and password, and the attacker uses it to access the user's real bank web site. The user doesn't realize until sometime later that the attacker has completed transactions against his account. In this case, the user isn't able to authenticate the bank and the bank isn't able to authenticate the user. Many other security vulnerabilities exist on the Internet.

Mutual authentication refers to two parties authenticating each other. Typically, users authenticate themselves to a server (e.g., web server) and the server authenticates itself to the user in such a way that both parties are assured of the others' identity.

### SUMMARY

Various embodiments of methods and systems for vetting service provider uniform resource identifiers (URIs) within a secure user interface are disclosed. A security component may be installed on a client system and execute in conjunction with the network-enabled application. A network-enabled application may be defined as any application that may receive information from a user and convey it over a network (e.g., the Internet).

The network-enabled application (e.g., web browser) may receive display information (e.g., a web page) from a relying party (e.g., a web site) and display the information within a window. The security component may be configured to initiate the display of an embedded region as a subset of the window drawn by the network-enabled application. At least a part of the displayed embedded region may be defined by the component and not by the relying party.

The security component may be configured to send a request to a reputation service for reputation information about the relying party and receive a response from the reputation service. The security component may display an indication of the relying party's reputation on the display of the embedded region.

In response to receiving reputation information from the reputation service indicating the relying party is not reputable, or not known to be reputable, the security component may prevent the network-enabled application, or a user thereof, from sending information to the relying party. Further, the security component may display an indication of the relying party's reputation in the embedded region of the user interface.

In some embodiments, the reputation service may employ one or more lists indicating reputation information for relying parties. In some cases one or two lists may be referenced. A “white” list may include a list of relying parties known to be reputable and a “black” list may include a list of relying parties known to be unreputable. The security component may display an indication of the relying party's reputation on the display of the embedded region based on the relying party's reputation as indicated in the list(s).

### BRIEF DESCRIPTION OF THE DRAWINGS

FIG. 1 is a block diagram illustrating a system for vetting service provider uniform resource identifiers (URIs) within a secure user interface, according to some embodiments.

FIG. 2A is a block diagram illustrating a client system, according to some embodiments.

FIG. 2B is a block diagram illustrating importing and exporting a secure store, according to some embodiments.

FIG. 3 is a flow diagram illustrating a system for vetting service provider URIs within a secure user interface, according to some embodiments.

FIG. 4A is a flow diagram illustrating a security component, displaying an embedded region and requesting authentication from an assertion provider, according to some embodiments.

FIG. 4B is a flow diagram illustrating a security component requesting, receiving and forwarding an assertion token, according to some embodiments.

FIG. 5 is a flow diagram illustrating the provisioning of a client system, according to some embodiments.

FIG. 6 is a sequence diagram illustrating a security component authenticating a user's credentials and routing an assertion token from an assertion provider to a relying party, according to some embodiments.

FIG. 7 is a screen illustration of a network-enabled application with an embedded security component, according to some embodiments.

FIG. 8 is a block diagram illustrating a system for implementing a trusted embedded user interface, according to some embodiments.

While the system is described herein by way of example for several embodiments and illustrative drawings, those skilled in the art will recognize that the system is not limited to the embodiments or drawings described. It should be understood, that the drawings and detailed description thereto are not intended to limit the system to the particular form disclosed but on the contrary, the intention is to cover all modifications, equivalents and alternatives falling within the spirit and scope of the present system as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words, “include”, “including”, and “includes” mean including, but not limiting to.

### DETAILED DESCRIPTION OF EMBODIMENTS

### Introduction

A network-enabled application may be associated with an embedded security component, configured to display a user-customized region within a displayed document (e.g., web page). When a user sees a particular embedded region displayed within the application's user interface, he or she may be assured the network-enabled application will only send the user's information to reputable relying parties. The display customizations are owned and maintained by the user and not revealed to third parties. The customizations may be displayed consistently across all reputable sites the user may visit while using the network-enabled application.

The network-enabled application may connect to a relying party using the relying party's address (e.g., uniform resource identifier (URI)), and request a document (e.g., web page) or request a service (e.g., web service) from the relying party (e.g., web site). The user-customized embedded region is drawn by the security component embedded within the web page served by the relying party or within another interface brought up by the network-enabled application. At least part of the appearance of the embedded region is controlled by the security component (e.g., based on user-customizations) and not by the relying party.

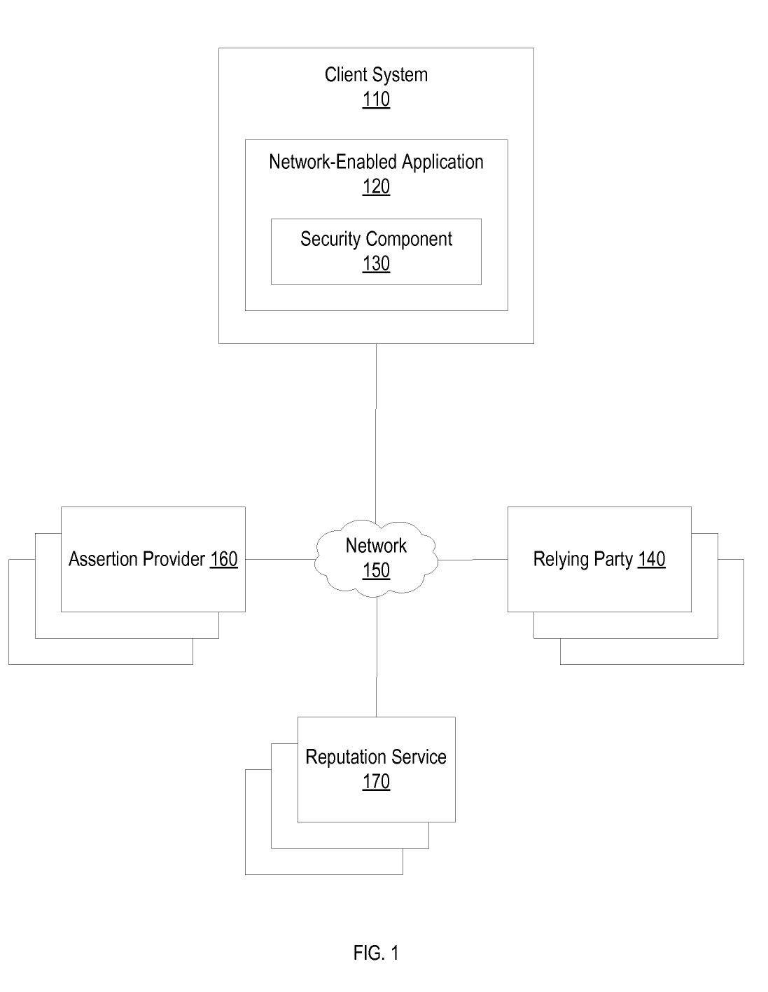

The security component may send the relying party's address to a reputation service via a secure channel (e.g., SSL) and request the reputation service determine the reputation of the relying party. A reputation service can be defined as an entity that tracks and/or reports on the trustworthiness of relying parties. Typically, a reputation service maintains a data store of relying parties and their reputations. In various cases, the reputation service may indicate “reputable”, “not reputable”, or “not known”. In some cases a reputation may be represented on a scale (e.g., 1-10, where 1 is lowest and 10 is highest). The implementation methods used by the reputation service can be one or more files (e.g., a “white list” and/or “black list”) certificates, or any other suitable method of tracking the reputation of relying parties. A reputation service can be accessed via a network, as shown in FIG. 1, or it can be accessed locally on client system 110 (not shown in FIG. 1).

The security component may display an indication of the relying party's reputation within the embedded region according to the reputation information received from the reputation service. In some embodiments, if the reputation information received from the reputation service indicates the relying party is not reputable, or the reputation service has no information on the relying party, the security component may prevent the network-enabled application from sending any information to the relying party and/or display an indication (e.g., within the embedded region) that the relying party is not trusted.

If the reputation information indicates the relying party is reputable, the security component may be configured to mutually authenticate the user's credentials with the relying party (e.g., web site). With mutual authentication, two parties (e.g., a client and server) may authenticate one another, such that both parties are assured of the others' identity.

The security component may display (e.g., within the embedded region) a link area to the reputation service. The link area may contain a graphic indicator, such as the logo image of the reputation service. The graphic indicator may be referred to as the reputation seal. In various embodiments, when the security component receives a mouse-over event, a mouse-click event, a keyboard event, or a similar event, the security component may reveal more information about the business (e.g., all memberships of the website, ratings of the website, etc.).

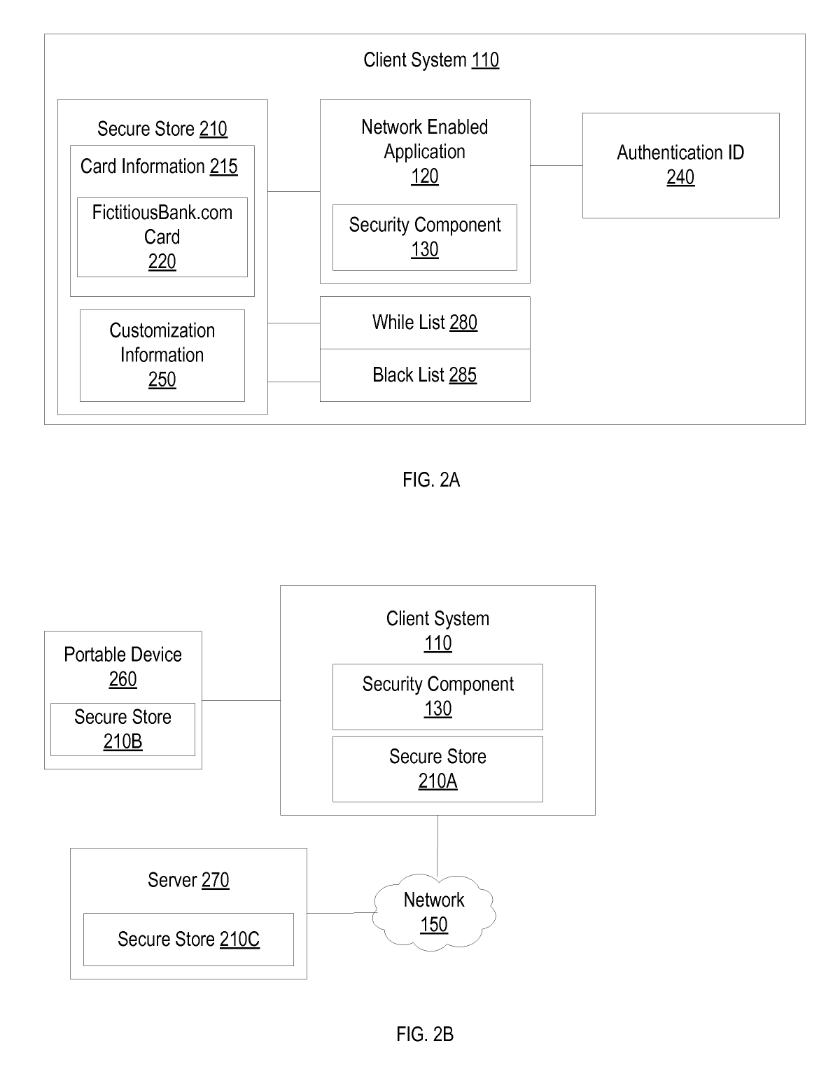

For certain interactions with rely parties, users of a client system may need to authenticate themselves. The security component may use one or more of a variety of authentication techniques to authenticate a user. Examples include username/password, challenge-response protocols (e.g., based on public-private key technology), smartcard-based authentication, or other suitable authentication techniques. In some embodiments, challenge-response protocols may not be based on shared secrets; sensitive information (e.g., a password) may not be transmitted to the relying party. A user of a client system may select an identity associated with a “Card” in order to authenticate to a relying party. A card is a metaphor for identity information and may include authentication information needed to securely access the relying party. (See the FIG. 2A discussion below for more information regarding cards.)

The security component on the client system may authenticate the user with an assertion provider (e.g., using the user's credentials) via a secure channel. The relying party may trust the assertion provider to authenticate the user's credentials. Once authenticated, the assertion provider may return a secure assertion token to the client system. An assertion token may be authentication data formatted in a way agreed upon by the assertion provider and the relying party. The client system may subsequently forward the assertion token (e.g., through a secure channel) to the relying party and the relying party may authenticate the user of the client system based on the assertion token. Once authenticated, the relying party may send secure documents (e.g., restricted web pages) or other information to the client system (e.g., also via a secure channel). The authentication information exchanged between the assertion provider and the relying party may be in the form of an assertion token that may be signed by the assertion provider and may assert to the authenticity of some information, for example, a user's identity, a user's attributes and/or a user's payment for some product or service. Thus, the security component may serve as an assertion router between an assertion provider and a relying party. In various embodiments, the methods and systems described herein may be used for a client system to retrieve sensitive information from a relying party or engage in a transaction where sensitive information is securely exchanged between a client and a relying party. Sensitive information may include, but is not limited to transaction information, social security numbers, credit card numbers, financial information, payment assertions and/or other information.

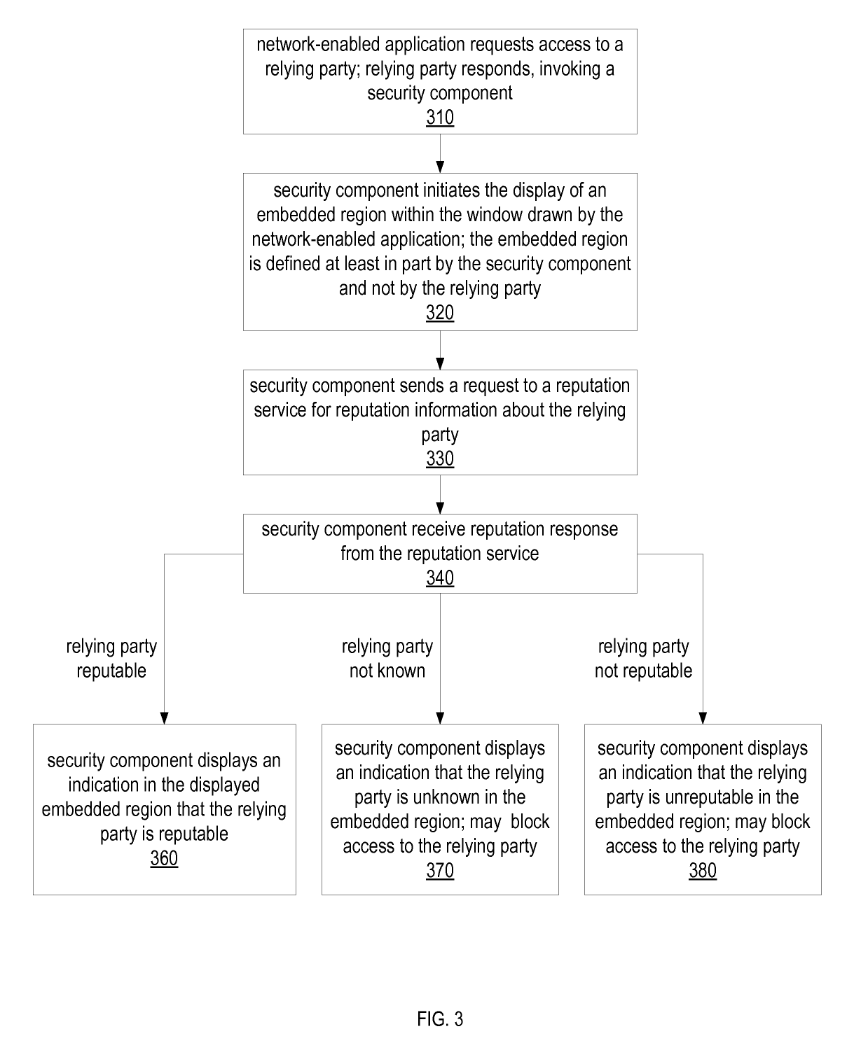

In some embodiments, a relying party may be issued a certificate to indicate its trustworthiness. A visual representation of the certificate may be displayed within the embedded region as an indicator that the relying party has been certified as trustworthy by issuer of the certificate. The security component may contact a reputation service (which may be the certificate issuer) to verify the certificate. The reputation service indicates to the security component whether or not the certificate is valid. In one embodiment. The security component and/or reputation service may also or alternatively check a certificate revocation list and/or use Online Certificate Status Protocol (OCSP) to determine if the certificate has been revoked. The trust indicator is only displayed in the embedded region if the certificate is valid. The certificate may further be used to verify the communication channel to the relying party. In some cases, the certificate issuer may charge the relying party a fee for certification. See the description of FIG. 3 for more information regarding certificates.

### Overview

FIG. 1 is a block diagram illustrating a system for vetting service provider uniform resource identifiers (URIs) within a secure user interface, according to some embodiments. Client system 110 may be any device configured to connect to network 150, and execute a network-enabled application. Examples of client system 110 include a personal computer, a server, a cell phone and a Personal Digital Assistant (PDA). Other implementations have been contemplated. Client system 110 may include a network-enabled application 120.

Network-enabled application 120 may be implemented as an application configured to connect to network 150 and exchange information with relying party 140, reputation service 170 and assertion provider 160. Network-enabled application 120 may be configured to display a user interface and receive user input from an input device. In various embodiments, network-enabled application 120 may be implemented as a web browser. Examples of web browsers include Microsoft Internet Explorer™, Opera™, Safari™ and Mozilla™ FireFox™. In other embodiments, network-enabled application 120 may be implemented as a stand-alone application program (e.g., not a web browser) configured to communicate with relying party 140, reputation service 170 and assertion provider 160 via network 150. Network-enabled application 120 may display web pages, text, images, videos, play music, and retrieve documents and/or web pages from one or more relying parties 140 (e.g., web sties) on the Internet, on a wide area network, on a local area network, or on another type of network. Network-enabled application 120 may execute on any suitable operating system, such as Microsoft™ Windows XP™, Vista™, Windows Mobile™, Linux, Unix™ and MacOS™, or another suitable operating system.

Network-enabled application 120 may communicate with relying party 140 using hypertext transfer protocol (HTTP) to fetch web pages, images and other documents. Secure communication protocols may be used. (See the discussion below regarding network 150 for more information regarding secure network protocols.)

The file format of documents and images served by relying party 140 and received by network-enabled application 120 may be implemented in, or utilize hypertext markup language (HTML), Active Server Pages™, Extensible Markup language (XML) JPEG, GIF, or another document or image type. Relying party 140 may send, and network-enabled application 120 may receive scripting code (e.g., JavaScript™) that may affect the behavior of network-enabled application 120.

Network-enabled application 120 may be configured to execute one or more plug-ins. A plug-in may be defined as a computer program that interacts with network-enabled application 120 to provide a specific function “on demand”. Network-enabled application 120 may provide services used by the plug-in, including a way for the plug-in to register itself with network-enabled application 120 and a protocol with which data may be exchanged with the plug-in. A plug-in may be dependent on the services provided by network-enabled application 120 and may not work without them. Conversely, network-enabled application 120 may be independent of the plug-in, making it possible for one or more plug-ins to be added and updated dynamically without changes to network-enabled application 120. A plug-in may rely on the network-enabled application's user interface. Plug-ins may be implemented as shared libraries that may be installed in a place prescribed by network-enabled application 120. In some embodiments, the plug-in may provide virtual machine functionality. The virtual machine may run scripting code that may be compiled into byte code and may be executed by the plug-in virtual machine. In some embodiments, Adobe Flash™ may provide virtual machine capabilities and security component 130 may be implemented as a Flash™ component, compiled as a .swf file. In some embodiments, the virtual machine may include, or provide access to native extensions for cryptographic functions and secure storage, which may be available to the plug-in and components (e.g., security component 130).

Security component 130 may be implemented as a component of network-enabled application 120. In various embodiments, security component 130 may be implemented as a plug-in or a component of a plug-in utilized by network-enabled application 120. Security component 130 may be implemented as an Active-X™ component or a widget. In some embodiments, security component 130 may be written in a scripting language and compiled into byte code. Relying party 140 may directly or indirectly invoke security component 130 on client system 110. For example, security component 130 may be downloaded from a web site (e.g., embedded in a web page) and invoked by network-enabled application 120 when received. In another case, a reference to security component 130 may be downloaded from a web site, also embedded in a web page and network-enabled application 120 may use the reference to access and invoke security component 130. Once invoked, security component 130 may interact with a plug-in or a virtual machine installed on client system 110.

In some embodiments, security component 130 may be integrated with, or be part of network-enabled application 120. Security component 130 may be implemented as one or more shared libraries (e.g., dynamic link library). In some cases, security component 130 may be installed from a storage medium (e.g., CD-ROM).

Security component 130 may be downloaded from relying party 140 or a third party server (e.g., web site) other than relying party 140, such as a security component vendor server. In some cases, security component 130 may be signed and loaded by network-enabled application 120, which may verify the signature.

Security component 130 may be configured to share data with network-enabled application 120 and may display information within one or more windows drawn by network-enabled application 120. Security component 130 may draw a region (e.g., rectangle) as a subset of an existing window drawn by network-enabled application 120. For example, in a web implementation network-enabled application 120 may be implemented as a web browser and may display a document (e.g., HTML document) within the web browser's main window. Component 130 may draw a region (e.g., rectangle) within the main window where the document is displayed. The embedded region may not be a separate dialog box, pop-up or a separate window, but rather an integral part of a window drawn by the network-enabled application A window may be defined as any interface that can be displayed on a display device. A window may or may not have borders, a title bar and a menu bar. A window may or may not be opaque. A window may be displayed as a rectangle, circle, oval or another shape. Text, buttons, images, and any other object that can be represented on a display device may be displayed in the window. The security component's embedded region may be displayed as part of an interface (e.g., within a window or otherwise) drawn by the network-enabled application 120.

Security component 130 may be configured to access the operating system of client system 110 as well as access the file system and/or any hardware device, including hardware devices used for cryptographic and/or authentication purposes (e.g., SmartCard™). Security component 130 may have access to native cryptographic APIs, classes, methods, services, libraries, functions and frameworks (e.g., .NET™, J2EE™) of client system 110.

Security component 130 may have access to security capabilities that are available on client system 110, including security capabilities provided by Windows™, MacOS™, Linux, Unix™, Firefox™, Internet Explorer™ and other applications. Security component 130 may have access to Microsoft™ Cryptographic Programming Interface™ (CAPI). Security component 130 may have access to credentials stored in a Mac Key Chain, another key chain or credentials stored by Credential Service Providers (CSP).

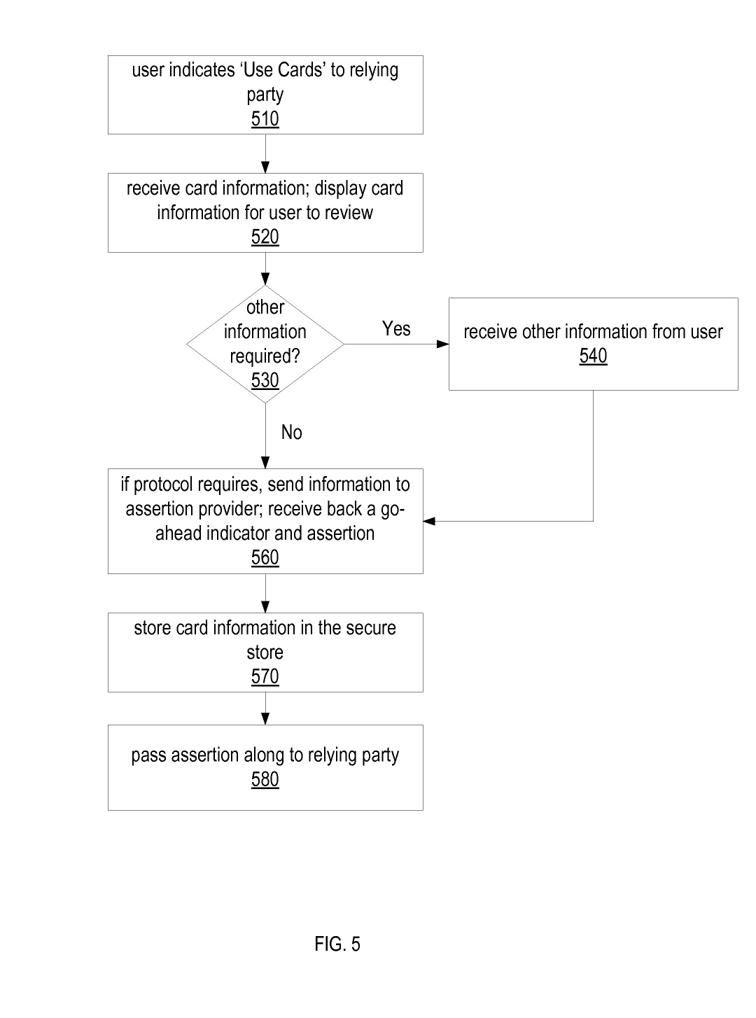

In some embodiments, security component 130 may be configured to store digital Ids, certificates and other secret information (e.g., authentication ID 240). Digital Ids may be stored and retrieved consistently across platforms (e.g., operating systems and file systems). For example, in one embodiment security component 130 may utilize Public-Key Cryptography Standard #12 (PKCS#12). Security component 130 may provide a common method of provisioning and accessing new credentials and/or identification information across operating systems and file systems. (See the description of FIG. 5 for more information.)

When network enabled application 120 authenticates credentials with relying party 140, security component 130 may display data within a region (e.g., a rectangle) embedded in a window or web page displayed by network-enabled application 120. The information displayed within the region assures the user that the information is from a trusted entity. Security component 130 may determine the reputation of a relying party by communicating with a reputation service and display an indication of the relying party's reputation in the embedded region. The embedded region may be used for interaction with the user of network-enabled application 120. For example, if the relying party is reputable, security component 130 may display the embedded region and interact with relying party 140. The embedded region may be used to display information that may only be revealed to the user for security and privacy reasons. The region may list all of the user's available identities associated with a relying party 140.

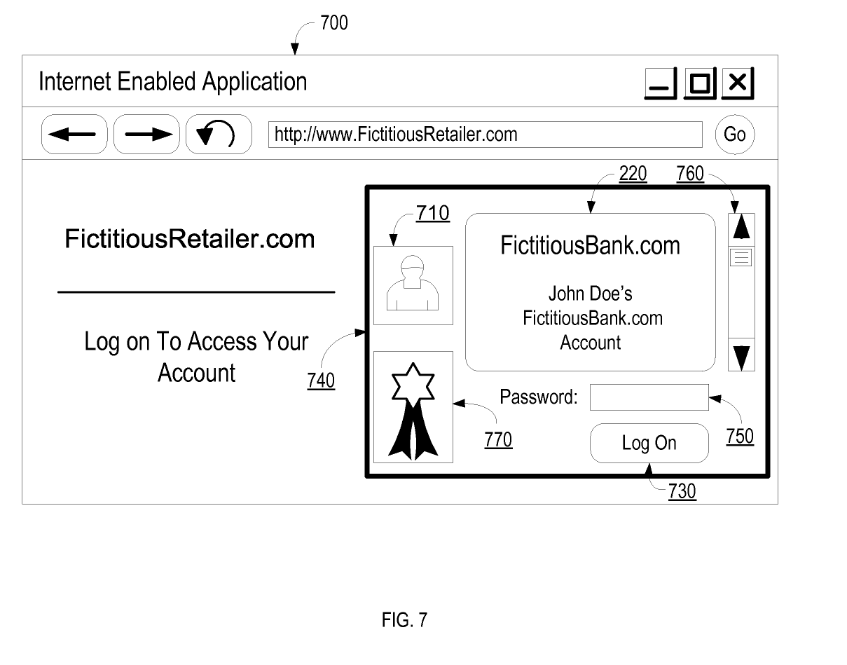

The user may customize the appearance of the embedded region. Customizations may include user selected images, border colors, text, background colors, border widths and/or background images. The customizations may be displayed in a way to make it difficult for an attacker to access the customized display. The customizations ensure that any information presented to the user may be trusted. The customizations may be displayed consistently for all relying parties 140 visited (i.e., the customizations may not be relying party 140 specific), and may only be shown for relying parties 140 that are established by the security component as being reputable. Non-reputable relying parties 140 may not be able to invoke the security component. (See the discussion below regarding FIG. 7 for more information regarding the displayed region.)

Relying party 140 may be any trusted system configured to connect to network 150 and communicate with client system 11 0. In some embodiments, relying party 140 may be implemented as a web server. Relying party 140 may service requests from client system 110. Relying party 140 may be configured to listen on a port (e.g., port 80) waiting for client system 110 to send a request message. When relying party 140 receives a request, relying party 140 may be configured to fetch content (e.g., web page) and forward the content to client system 110. Relying party 140 may be implemented as one or more physical systems connected to one or more storage devices. Relying party 140 may be configured to run special web server software configured to service client system 110 requests. Examples include Microsoft™ Internet Information Systems™ and Apache™. Other server host application software is possible. In some embodiments, relying party 140 may provide web services or be implemented as an application server.

Assertion provider 160 may be any system that provides authentication services for users of client system 110 and relying party 140. Relying party 140 may trust and rely on assertion provider 160 to authenticate identify, or other information about the user of network-enabled application 120. In some embodiments, assertion provider 160 and relying party 140 may be controlled by the same entity. For example, a bank (e.g., relying party 140) may provide it's own authentication services (e.g., assertion provider 160). In other embodiments they may be controlled by separate entities.

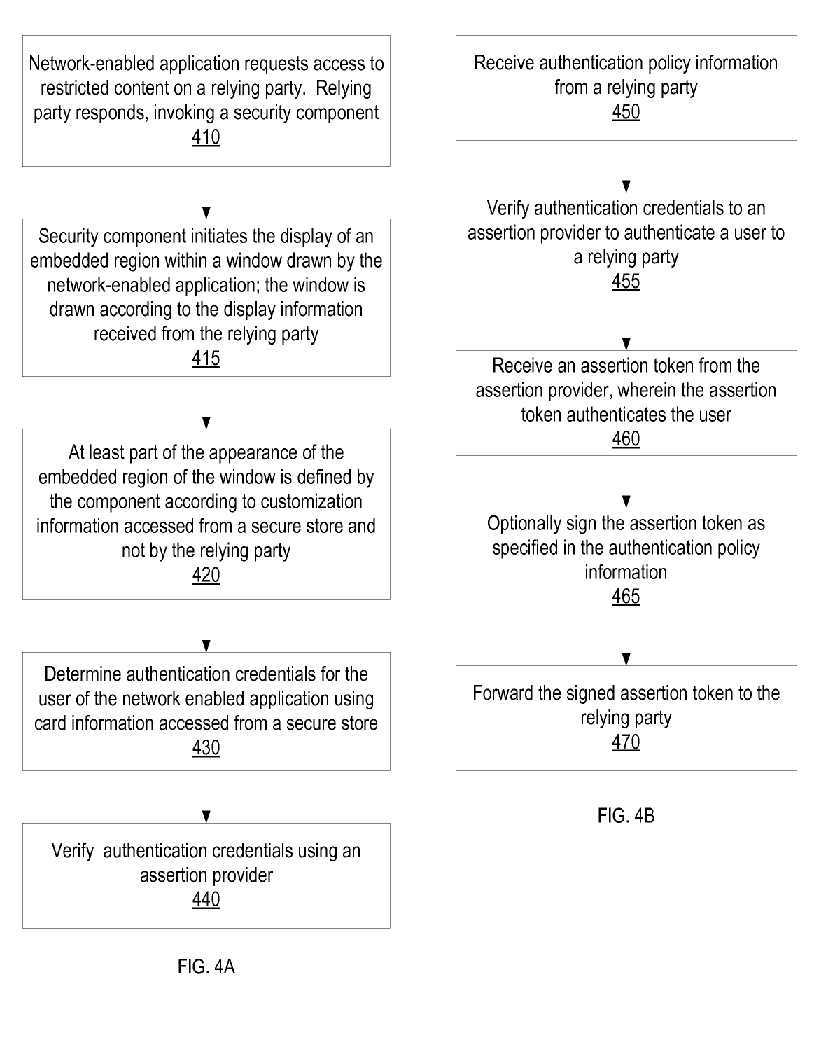

Assertion provider 160 may use the Security Assertion Markup Language (SAML) standard for exchanging authentication and authorization data with security component 130 and/or relying party 140. SAML is meant as an example and other suitable standards and/or protocols may be used. At the request of security component 130, assertion provider 160 may receive the user's credentials, and if the user is authenticated, pass a SAML assertion in the form of a token back to security component 130, which may forward the assertion token to relying party 140 for authentication purposes. The assertion token may include other information, such as transaction information, user attributes, digital certificate, payment information and/or a private or public key. In various embodiments, the assertion token may assert a user's rights and/or permissions. In other embodiments the assertion token may assert to a user's email address or memberships, or other information. (See the discussion below for FIGS. 4A and 4B for more information regarding assertion tokens and authentication.)

In various embodiments, reputation service 170 may be configured to determine the reputation of one or more relying parties 140. Reputation service 170 may rate the threat level of relying parties 140. If reputation service 170 sends reputation information to security component 130 indicating a relying party is a threat, security component 130 may display an indication of the threat level in the displayed embedded region and may disable the network-enabled application from sending information to the relying party 140 in an attempt to protect users from malicious web sites.

Reputation service 170 may utilize a number of factors to determine if a relying party 140 is reputable. For example, reputation service 170 may determine how long the relying party 140 has been in existence; determine whether relying party 140 contains downloadable code; determine the volume of visitors to relying party 140; determine if the relying party's URI is similar to a popular domain's URI, and therefore may be masquerading as the popular domain. Many other techniques may be used to determine the reputation of the relying party.

Reputation service 170 may be configured to receive a reputation request from security component 130. The request may be sent via secure channel and reputation service 170 may respond via secure channel. In various cases, reputation service 170 may return an indication of, “reputable”, “not reputable”, or “not known” (meaning the reputation service has no information on the relying party 140). In other cases, reputation service 170 may rate the relying party on a scale (e.g., 1-10) or utilize another rating method. Security component 130 may send a URI to reputation service 170 and reputation service 170 may rate the relying party based on the URI. In some cases, security component 130 may send another unique identifier for relying party 140, such as a domain name, IP address, phone number, street address or another suitable relying party identifier.

In various embodiments, network 150 may be configured to allow data to be exchanged between client system 110, reputation service 170, relying party 140, and assertion provider 160. Network 150 may correspond to various methods of communication between entities and may include, but is not limited to communication via telephone, fax, email, messages (e.g., instant messaging), voice messages, and electronic documents (e.g., web page, email or file transfers). In general, network 150 may represent any method that one entity may utilize to communicate with another entity. While network 150 may be illustrated in a generalized manner, one of ordinary skill in the art will recognize that network 150 is meant to be representative of a complete communication path between the entities depicted in FIG. 1 with a specific type of communication channel. For example, network 150 may represent one or more communications channels and may include one or more telecommunications networks as well as various data networks. Network 150 may include network devices such as circuits, switches, routers, hubs and/or gateways. Network 150 may support communication via wired or wireless general data networks, such as any suitable type of network including the Internet and/or Ethernet LAN; via telecommunications/telephony networks such as analog voice networks or digital fiber communications networks; via storage area networks such as Fiber Channel SANs, or via any other suitable type of network and/or protocol. Data may be transmitted on network 150 using Hyper Text Transport Protocol (HTTP), Secure Hyper Text Transport Protocol (HTTPS), Secure Socket Layer Protocol (SSL), Transport Layer Security Protocol (TLS) or another suitable network transport protocol. In various embodiments, the services described herein may utilize any suitable cryptographic protocol and/or cryptographic algorithm when communicating over network 150.

Following is a description of one example workflow implementation. A user associated with network-enabled application 120 may send a request for a restricted document to relying party 140. Relying party 140 may return a web page or login form to network-enabled application 120, which may direct network-enabled application 120 to invoke security component 130. Security component 130 may send the URI of the relying party to reputation service 170 using a secure channel (e.g., Secure Socket Layer (SSL) protocol). In some embodiments, security component 130 may sign the URI before sending it to reputation service 170. Reputation service 170 may determine the reputation of relying party 140 and send a response back to security component 130. In this example, the reputation information may indicate relying party 140 is reputable. Security component 130 may display an indication (e.g., a gold certificate or a logo of the reputation service) in the embedded region and also display cards and user customizations. When the user sees the customized region, he or she may be sure of interacting with a trusted relying party 140.

Security component 130 may select one or more cards associated with relying party 140 from secure store 210 and display the one or more cards, which represent identities that the user previously established with relying party 140. To select one or more cards for display, the security component 130 may filter cards from secure store 210 according to a policy file. The and one or more selected cards may be displayed within the embedded region. Each displayed card may be associated with an assertion provider, and the user may select one of the displayed cards in order to be authenticated. If relying party 140 is a rogue site (e.g., determined by reputation information received from reputation service 170), security component 130 may not display any cards in the embedded region and may not allow the user to enter authentication information. Once the user has selected a card (e.g., identity) and entered any needed information required for authentication (e.g., a password), an authentication request for the user's credentials may be securely sent (e.g., SSL or TLS) to assertion provider 160. Relying party 140 may trust assertion provider 160 to authenticate user credentials.

Assertion provider 160 may validate the credentials and if successful, return an assertion token to security component 130. In some embodiments the assertion token may comprise an ephemeral <certificate, private key>. Assertion provider 160 may sign the assertion token. The assertion token, authenticating the user of network-enabled application 120, may then be returned to relying party 140. In some embodiments the assertion token may be returned in the form of a cookie.

Security component 130 may sign the assertion token in a way specified by relying party 140. The instructions for how the assertion token should be signed may be specified in the policy file and copied to secure store 210 at registration/provisioning time. In some embodiments, the assertion token may be signed in a manner that only allows it to be used once. In one example, security component 130 may sign the assertion token using the private key received from assertion provider 160. Security component 130 may add the URI of relying party 140 to the assertion token so that relying party 140 can't replay it to other relying parties 140. In another case, security component 130 may add a nonce and/or a timestamp to the assertion token. (The nonce may have previously been received from relying party 140 and associated with a current session between client system 110 and relying party 140.) Other information may be added to the assertion token. In some cases, security component 130 may receive the assertion token from assertion provider 160 and pass the assertion token to relying party 140 without adding any additional information to the assertion token.

In a web browser implementation, after security component 130 has received the assertion token from assertion provider 160 and added any necessary information, security component 130 may forward the assertion token to network-enabled application 120, which may forward it on to relying party 140. The assertion token may be passed to relying party 140 as a query parameter, a token or an authorization header. Other methods are possible. In cases where the security component is tightly coupled to the network stack, the assertion token may be passed directly to relying party 140 without the intermediate step of passing the assertion token to the network-enabled application 120. In either case, the channel used to transport the assertion token to relying party 140 may be secure (e.g., SSL or TLS). Once the assertion token has been received, relying party 140 may authorize network-enabled application 120 to exchange restricted content with relying party 140. Restricted content may comprise a restricted document, transaction information or some other suitable information.

### Policy File Description

In some embodiments, a policy file may specify authentication and communication settings and protocols. A policy file may include all of the information security component 130 needs to authenticate a user's credentials with relying party 140. One or more policy files may be located on relying party 140. Additional policy files may be located on assertion provider 160. Security component 130 may be configured to access one or more policy files on relying party 140 and/or assertion provider 160. In some embodiments, security component 130 may access policy file information or receive policy file information when network-enabled application 120 initially registers with relying party 140. In one embodiment, at registration or provisioning time, settings and specification information may be copied from the policy file into secure store 210. (See the description below regarding secure store 210 for more information on provisioning.) In another embodiment, policy file information may be accessed by security component 130 when security component 130 authenticates a user's credentials with relying party 140.

Security component 130 may be configured to download, receive, access, read, validate and parse one or more policy files. Policy file information may be stored in an Extensible Markup Language (XML) or another suitable format.

As described above, policy file information may include information for both registration and authentication scenarios. Correspondingly, there may be at least two types of policy files. One type of policy file may be used for registration. Registration is the process where a network-enabled application 120 (e.g., on client system 110) initially accesses and registers with relying party 140 and/or assertion provider 160. In this case, security component 130 may access policy file information to determine what information is required for registration. Security component 130 may read policy file information and exchange registration information with relying party 140 and/or assertion provider 160. Another type of policy file may be an authentication policy file. Policy file information may include information used by security component 130 when authenticating a user with assertion provider 160. For example, the authentication policy may specify how to pass the assertion from assertion provider 160 back to relying party 140.

Policy file information may include filtering information, such as specifying a list of one or more assertion providers 160 relying party 140 may accept for authentication purposes. Filtering information describes which cards may be shown within the embedded region for a particular relying party 140.The list may include the address of the assertion providers 160 (e.g., URI). Policy file information may include a list of filtering characteristics to be used when security component 130 selects an assertion provider 160. For example, filtering characteristics may include specific cryptographic authentication protocols, whereby only assertion providers 160 supporting the specified authentication protocols may be acceptable. In another example, filtering characteristics may specify that only assertion providers 160 under a particular root certificate authority may be acceptable. In another example, filtering information may specify that only a card related to a particular username/password may be displayed.

In other embodiments, policy file information may include a description of how authentication should be performed between security component 130 and assertion provider 160 (e.g., challenge/response, public key, username/password).

As described above, assertion provider 160 may return an assertion token to security component 130 after the user's credentials are successfully authenticated. Policy file information may include information regarding how the assertion token should be formatted, as well as a description of how the assertion token should be routed from assertion provider 160 to relying party 140. In one example, policy file information may specify that the assertion token should be passed as a form parameter in an HTTP request. In another example, policy file information may specify that the assertion token may be passed in an HTTP header or in the body of an HTTP request. Other methods and protocols are possible.

Policy file information may include additional information required by relying party 140 before the assertion token is sent from security component 130 to relying party 140. In various embodiments, relying party 140 may require that security component 130 sign the assertion token, include a timestamp or include other information, such as a nonce.

Policy file information may include information describing the appearance of the displayed embedded region related to relying party 140. Relying party information may be displayed by security component 130 within the embedded region. This information may include text and/or images. (See FIG. 7 for more information.) The amount of information relying party 140 can define for display purposes within the embedded region may be limited, so as not to defeat the anti-phishing aspects of the embedded region user interface (e.g., the user-customized appearance features controlled by the security component cannot be obscured or overwhelmed by the relying party).

Certain trusted relying parties 140 may be allowed to modify the appearance of portions of the displayed embedded region. For example, the vendor supplying security component 130 may issue a certificate to certain relying parties indicating an additional level of trust and only those relying parties with the certificate may be allowed to modify the appearance of portions of the embedded region. Thus, in some embodiments, two or more levels of trusted parties may exist. For example, regular trusted parties may be indicated as trusted or reliable in the embedded region display, but may not be able to modify or define certain portions of the embedded region display. A higher level trusted party may also be indicated as trusted or reliable in the embedded region display, and may additionally be able to modify or define certain or additional portions of the embedded region display. Any suitable criteria, such as user feedback, may be used by a reputation or certification service to determine whether or not a relying party qualifies as a higher level trusted party. The certification/reputation service may charge for certification services, including a fee (or additional fee) for certifying a relying party as a higher level trusted party.

Policy file information may include version information, describing the version of the policy file.

### Secure Store and Identity Card Description

FIG. 2A is a block diagram illustrating a client system 110, according to some embodiments. Secure store 210 may be an encrypted file containing all of the information needed for mutual authentication between security component 130 and one or more relying parties 140. Secure store 210 may not be accessible by relying party 140. Component 130 may be configured to digitally sign, encrypt and decrypt secure store 210. In some embodiments, parts of secure store 210 may be encrypted and other parts may not be encrypted. In other embodiments, all of secure store 210 may be encrypted. Secure store 210 may be signed by security component 130.

Security component 130 may have access to the client system 110 file system, cryptographic APIs, keys and/or digital IDs required to access secure store 210. Security component 130 may access secure store 210 using one or more common techniques across platforms (e.g., file systems and operating systems). In some embodiments, security component 130 may receive a user-supplied password prior to accessing secure store 210.

Secure store 210 may include, but is not limited to:
Date and time the user's credentials were last used. (This information may be displayed by security component 130.)
Customization Information 250. Customization information may comprise one or more graphical user interface customizations specified by a user and applied to the user interface displayed in the embedded region by security component 130. (See the discussion regarding FIG. 7 for more information about user customizations.)
The addresses of one or more reputation services to access in order to determine if a relying party 140 is reputable. Component 130 may be configured to allow the user to select the reputation service he/she wishes to use. (See the description below for FIG. 7 for more information.)
Receipts generated during previous authentication sessions (e.g., payments).
Available coupons (e.g., authentication assertion tokens).
Card information 215, including one or more identity cards. (See the description below for secure store 210 for more information on cards.)
Synchronization information (e.g., the last date/time secure store 210 was synchronized with a server).
A cache of recently tested-for-reputation URLs.

Client system 110 may include a white list 280 and black list 285. These lists may contain unique addresses (e.g., URIs) of known relying parties and may be located in secure store 210. White list 280 may contain a list of addresses of relying parties 140 known to be reputable. Black list 285 may contain a list of addresses of relying parties 140 known to be un-reputable. In some embodiments, network-enabled application 120 or security component 130 may be configured to add and remove addresses to white list 280 and black list 285 in response to user input. For example, a user associated with network-enabled application 120 may access a relying party 140 on a regular basis and may be sure the relying party is reputable. In this case, the user may add the address of the relying party to white list 280. Conversely, the user may know of one or more malicious relying parties 140 and add their addresses to black list 285. In some cases, white list 280 and black list 285 may be combined in one list; each relying party in the list may be associated with an indication of the relying party's reputation. In some embodiments, white list 280 and black list 285 may be downloaded (e.g., periodically, aperiodically, or on demand) from a trusted server (e.g., reputation service 170) and cached on client system 11O. Thereafter, security component 130 may access reputation information from the cache.

In some embodiments, white list 280 and black list 285 may be administered locally by a user associated with network-enabled application 120 as shown in FIG. 2A. In other embodiments, white list 280 and black list 285 may be maintained on a server, accessible by security component 130 via network 150. Security component 130 may be configured to access white list 280 and black list 285 to determine reputation information about relying party 140. Thus, the reputation service 170 may include either a local or a remote white list and/or black list. Accessing a white list and/or black list may be performed in addition to, or instead of other types of reputation vetting techniques performed by a reputation service 170.

FIG. 2B is a block diagram illustrating importing and exporting a secure store, according to some embodiments. Security component 130 may provide export and import capabilities for secure store 210A in order to allow users to roam to other systems. For example, security component 130 may import and/or export secure store 210A to server 270 (e.g., secure store 210C). Once exported the server 270, secure store 210C may be securely accessed by a user, using any system connected to a network, assuming the user has access to the proper credentials.

Security component 130 may import and/or export secure store 210 to portable device 260, (e.g., secure store 210B), which may be carried by a user to another client system. Examples of a portable device 260 include a SmartCard™, thumb drive, and USB key. Other portable devices have been contemplated. Component 130 may be configured to securely access data on the portable device using cryptographic APIs.

In some embodiments, security component 130 may periodically synchronize secure store 210A on client system 110 with server 270 and/or portable device 260. Security component 130 may be configured to synchronize secure store 210 automatically, without user intervention at a certain time interval. In other embodiments, the synchronization may occur in response to a user's request.

Security component 130 may be configured to access, read, write, encrypt and decrypt secure store 210 on portable device 260 and/or server 270. Digital identity cards may be stored in secure store 210. Identity card information (hereafter referred to as a “Card”) is information describing a persona or identity associated with a user. Each card may include information indicating how authentication may take place between network-enabled application 120 and a relying party 140. In some embodiments, when a user associated with network-enabled application 120 initially “Signs Up” or registers with relying party 140, assertion provider 160 and/or relying party 140 may provision client system 110 with card information, placed within secure store 210. In some cases assertion provider 160 may be the same entity as relying party 140. In other cases they may be separate entities. Security component 130 may filter and display one or more cards associated with a assertion provider 160. A card may include a username or some other credentials identifying the user. In some embodiments, a card may include location information for credentials located outside of secure store 210, for example, authentication ID 240.

Each identity card, which may be provided by an assertion provider, may include, but is not limited to:
Card Identifier—A unique identifier for the identity card.
Card Image—A unique image associated with the card and displayed by security component 130. The card image helps the user identify the card from other cards. In some embodiments, the card image may be an icon.
Card Name—The name of the card uniquely identifies it.
ID Type—The type of ID to be used for authentication. Examples include an enhanced username and password (e.g., Secure Remote Password Protocol (SRP)), Standard Digital ID (StandardID), Arcot™ Digital ID (ArcotID™), or any other suitable digital identification. (The ID's storage location may be determined by policy 145 when the ID is provisioned.)
ID Location—Where the ID is stored. The ID may be the user's authentication credentials associated with the assertion provider 160. In some embodiments the ID may be stored within the secure store 210 and in other embodiments the ID may be stored separately, such as in a separate file, separate folder, and/or on a storage device (e.g., disk storage, SmartCard). In some embodiments, the ID may be stored as a key in a digital key chain.
Access Options—How to access the ID. Examples include: (1) the user must enter a password to access the ID on each use, (2) the user must enter a password the first time the secure store 210 is accessed, and (3) the user may access the ID any time after logging into client system 110.
Assertion Provider Address—The addresses (e.g., Uniform Resource Identifier (URI)) for one or more assertion providers 160 with which authentication should take place.
Protocol Specification—Indicates how communication and authentication with the assertion provider should take place.
Expiration Information—Indicates when the card information may expire.
Relying party 140 logo, text, image and customized colors. Component 130 may be configured to control what information is displayed within the embedded region for each relying party 140.
Assertion Provider 160 logo, text, image and customized colors
Site Key. A site key may include a graphic image. The site key may be one of many images assigned to a particular user by a relying party 140 or assertion provider 160.

In some embodiments, policy file information may include add-on card information. Relying party 140 may designate (within policy file) the credentials (e.g., username and password, or OpenID) required to authenticate the relying party. In this case, security component 130 may retrieve this information and create an add-on card for the user at runtime. The add-on card may function the same way as any other card found in secure store 210.

### Workflow Description

FIG. 3 is a flow diagram illustrating a system for vetting service provider URIs within a secure user interface, according to some embodiments. As shown in block 310, a network-enabled application 120 may request access to a relying party 140. In various cases, the network-enabled application 120 may fetch a web page or make a call to a web service. Relying party 140 may respond, invoking security component 130. Security component 130 may initiate the display of an embedded region within a window drawn by network-enabled application 120, as shown in block 320. The window may contain a web page and the embedded region may be drawn within the web page by security component 130, which may define, at least in part, the appearance of the embedded region. Network-enabled application 120 may not define what is drawn within the embedded region.

In some embodiments, security component 130 may have a user configurable parameter that determines whether or not to check the reputation of a relying party 140. If the parameter is set, security component 130 may send the URI of the relying party 140 to a reputation service 170 and requests reputation information about relying party 140. If the parameter is not set, security component 130 may not request reputation information from reputation service 170.

A list of reputation services 170 may be obtained by security component 130 from secure store 210. The list may be user configurable or downloaded from a third party server by security service 130. In some embodiments, security component 130 may display the list of reputation services 130 in the embedded region and security component 130 may receive user input selecting the reputation service 170 to utilize. The displayed embedded region may also include a button, such as “Check Reputation.” When the user selects a reputation service 170 and selects the button, security component 130 may send a reputation request to reputation service 170 as shown in block 330. In other embodiments, security component 130 may automatically select the reputation service 170 without receiving user input. Security component 130 may determine the URI of the relying party 140 and send a secure request to the selected reputation service 170 for reputation information about the relying party 140.

In some embodiments, reputation service 170 may be implemented on a remote server accessible via network 150. In other embodiments, reputation service 170 may be implemented as a local application on client system 110. When implemented locally, security component 130 may periodically retrieve reputation information about a plurality of relying parties from a remote reputation service server and cache the reputation information on client system 110, much like a virus scan utility periodically downloads virus definitions. Security component 130 may access the cache directly to determine reputation information, or in another embodiment security component 130 may communicate with the local reputation service 170, which may access the cache and return reputation information to security component 130.

In some embodiments, security component 130 may sign the URI or the entire request prior to sending it to reputation service 170. Subsequently, security component 130 may receive a response from reputation service 170 indicating reputation information about relying party 140, as shown in block 340.

In some embodiments, security component 130 may cache the reputation response from reputation service 170. If network-enabled application 120 subsequently visits the same relying party 140, or requests another document from the same domain, component 130 may access the cache of reputation information responses prior to sending another request to reputation service 170. If the reputation information for the relying party 140 is in the cache, component 130 may use the cached reputation information rather than make additional requests to reputation service 170. In some embodiments, component 130 may be configured to set a user configurable parameter designating how long reputation response stay in the cache.

Component 130 may read the reputation information and determine if the relying party 140 is “reputable”, “not reputable”, or “not known”. If relying party 140 is not known, flow proceeds to block 370. Security component 130 displays an indication (in the embedded region) that the relying party 140 is not known. Security component 130 may disable communication with the relying party. For example, communication may be disabled in cases when less secure authentication is required (e.g., passwords). Whether or not communication to relying party 140 is disabled in the event that the relying party is not known may be a configurable option.

In the case where the relying party is reputable, flow proceeds to block 360In this case, the security component 130 displays an indication in the embedded region noting the relying party is reputable and displays user customizations and any cards associated with relying party 140.

In the case where the relying party is not reputable, flow proceeds to block 380. In this case, security component 130 displays an indication in the displayed embedded region that relying party 140 is not reputable. For example, a large ‘X’ may be displayed. In this case security component 130 may block communication with relying party 140. Blocking communication with relying party 140 in the case where the relying party is found to be un-reputable may be a configurable option.

Another approach to determining reputation is to determine reputation by use of certificates. A certificate may indicate trustworthiness. A relying party may obtain a signed certificate from a third party vendor or another trusted authority. The certificate may include the domain name of the relying party embedded in it. Security component 130 may receive the certificate from the relying party and may verify the certificate with the reputation service (e.g., the entity that issued the certificate). If the certificate is not valid, then the relying party may be considered un-reputable. Security component 130 may also check the URI of the relying party against the domain/URI in the certificate. If they match, the relying party may be considered reputable. If they don't match, the relying party may be considered un-reputable. Security component 130 or reputation service may also be configured to check a certificate authority's Certificate Revocation Lists (CRLs) (or another authority) to determine if a certificate has expired. If the certificate has expired, the relying party may be considered to be un-reputable.

FIG. 4A is a flow diagram illustrating a security component displaying an embedded region and requesting authentication from an assertion provider 160, according to some embodiments. As shown at block 410, network-enabled application 120 may request restricted access to a document or content (e.g., web page) located at relying party 140. For example, network-enabled application 120 may request a page associated with a “Check Out” web page (associated with a “Secure Cart”), after purchasing one or more items online. Relying party 140 may respond, and rather than being directed to a traditional login form requesting a username and password, network-enabled application 120 may be directed to security component 130. Security component 130 may display an embedded region within a document (e.g., web page) returned by relying party 140 and drawn by network-enabled application 120 as shown in block 415. If the user associated with client system 110 has previously registered with relying party 140 and assertion provider 160, one or more cards may be available in secure store 210. Security component 130 may access secure store 210 and display one or more cards. Relying party 140 may designate which cards are displayed by providing filtering information (e.g., cards for assertion providers capable of processing payment assertions). In some embodiments, if the user associated with network-enabled application 120 has not registered with relying party 140 and no card is available to authenticate the user with the relying party 140, the embedded region may not be displayed, or may be displayed with a visual indicator (e.g., large red ‘X’), or display a message suggesting the user may not have previously registered with relying party 140. In this case, component 130 may be disabled so that the user cannot attempt to access relying party 140.

Security component 130 may display the embedded region with a user interface customized by the user of client system 110. The user customizations may have been configured by security component 130 (or another application) in response to user input. The user may select colors, borders, border width, background images and other images to display within the embedded region. Other customizations are possible. The displayed customizations are meant to prevent phishing and indicate to the user that security component 130 has provided an assurance that the user's credentials and sensitive information are protected. The user-defined customizations may be displayed consistently for all relying parties that are established by security component 130 as being reputable. In other words, the user customizations are displayed for all cards displayed in the embedded region. Non-reputable relying parties 140 may not be able to invoke security component 130. Thus, security component 130 (not relying party 140) may control at least part of the appearance of the embedded region according to customization information accessed from secure store 210, as shown in block 420.

Security component 130 may determine a relying party 140 is reputable by accessing a reputation service 170, either locally on client system 110 or on a server accessible via network 150. The reputation service 170 may include a list of trusted, reputable relying parties 140. In some embodiments, the security component 130 may access a “White List” and a “Black List”, either locally on client system 110 or on a server, accessible via network 150. The white list 280 may include a list of relying parties 140 that are known to be trusted and the black list 285 may include a list of relying parties 140 that are known to be untrustworthy. In various cases, a user, a system administrator or a third party reputation service may maintain these lists. If a user associated with component 130 tries to access a relying party 140 on the black list 285, component 130 may be disabled and may display a warning.

As noted above, the location of one or more reputation services 170 utilized by security component 130 may be indicated in secure store 210, policy file information or indicated in another suitable location, such as a server accessible by security component 130. Security component 130 may send a request to a reputation service 170 requesting the reputation service 170 determine the reputation of a relying party 140. For example, security component 130 may make a web service call to a reputation service 170 requesting the reputation service 170 provide information about a specified relying party 140. Security component 130 may receive a response back from the reputation service indicating the relying party 140 is reputable or not reputable. Subsequently, security component 130 may only display card information in the embedded region for relying parties 140 that are deemed reputable. In some cases, if relying party 140 is found to be un-reputable, component 130 may display an indication in the embedded region. For example, component 130 may display a large red ‘X’, text images or other visual queues indicating the relying party 140 is not reputable and the user associated with network-enabled application 120 should not exchange information with the relying party 140. Component 130 and/or network enabled application 120 may be disabled so that the user may not attempt to log on to, or exchange information with relying party 140.

In some embodiments, when a user interacts with the security component's embedded region, other portions of the computer screen may be grayed and/or inactive to impede the obscuring of the embedded region. For example, the embedded region displayed by security component 130 may be implemented as a top window and configured so as not to be obscured by another object displayed on the user interface.

In some embodiments, component 130 may be configured to detect when the displayed embedded region is obscured. For example, component 130 may create a memory buffer and copy video screen display information (e.g., pixel information) about the embedded region into the buffer. Periodically (e.g., every second) component 130 may compare the actual screen display data to the display information in the memory buffer. If the two are identical, component 130 may determine the screen may not have been obscured. If the two are different, component 130 may determine the screen may have been obscured. In the case where component 130 detects the embedded region may have been obscured, component 130 may alter the display of the embedded region. For example, some elements may not be displayed within the embedded region and/or a message may be displayed within the embedded region notifying the user that component 130 has detected the embedded region may have been obscured. In other cases, a dialog box, a message box or pop-up window may be displayed notifying the user that the embedded region may have been obscured.

As shown in block 430, the user may select an identification card and enter any required credentials. In some embodiments, the card selected by the user may indicate credentials (e.g., password) must be entered. Relying party 140 may designate whether or not credentials are required for authentication. For example, a bank web site may require a password, whereas a blog web site may not. The bank may have higher security requirements. In some embodiments component 130 may determine the authentication credentials to use according to card information 215 accessed from secure store 210. In other embodiments, component 130 may create a card-add-on based on information accessed in the policy file.

Security component 130 may determine which assertion provider 160 is associated with relying party 140. In some embodiments, this information may be obtained from the card information in secure store 210. As shown in block 440, security component 130 may connect to assertion provider 160 via secure channel, verify the user's credentials using assertion provider 160 to authenticate the user.

FIG. 4B is a flow diagram illustrating a security component requesting, receiving and forwarding an assertion token, according to some embodiments. [0095] As shown in block 450, security component 130 may receive authentication policy information from relying party 130. The policy information may be received when network-enabled application 120 accesses relying party 140 and requests access to a restricted document or service. As described in the description of FIG. 4A, component 130 may retrieve card information 215 associated with relying party 140 and select an assertion provider 160 based on the card information 215. Component 130 may verify authentication credentials using an assertion provider to authenticate a user to relying party 140, as shown in block 455. Upon successful authentication, component 130 may receive an assertion token back from assertion provider 160, as shown in block 460. In some embodiments, component 130 may sign the assertion token as specified in the authentication policy information. (See block 465.) In some cases, component 130 may sign the assertion token with a private key retrieved from the assertion token received from assertion provider 160. The private key may be a public/private one-time-use key. In other cases, component 130 may sign the assertion token with another key (e.g., authentication ID 240) located on client system 110. Other keys may be used. As shown in block 470, component 130 may forward the signed assertion token to relying party 140 and relying party 140 may grant access to network-enabled application 120 based on the assertion token.

### Registration and Provisioning

FIG. 5 is a flow diagram illustrating the provisioning of a client system 110, according to some embodiments. In one case, Internet-enabled application 120 may request restricted content from relying party 140 and relying party 140 may determine that the user associated with Internet-enabled application has never enrolled with relying party 140.

Relying party 140 may provide a hint (e.g., link) to an enrollment document (e.g., web page) and request the user associated with Internet-enabled application 120 submit enrollment information (e.g., name, address, email, etc.), which may be required in order to enroll with relying party 140. In another case, the user may already be enrolled with relying party 140 and the user may be ‘upgrading’ to use the card-based mechanism described herein. If the user is already registered or enrolled with relying party, the relying party may already have some or all of the enrollment information needed to upgrade the user to use the card-based mechanism described herein.

As shown in block 510, the user may indicate he or she wishes to use a card-based security mechanism. For example, the user may select, or “click,” on a link for “Use Cards” or may respond to an invitation from the relying party. As shown in block 520, a policy file may be retrieved that contains card information, which may be displayed for the user to review. The user may verify the displayed information. In some cases, other information (e.g., password) may be required, as shown in block 530. In this case security component 130 may receive the additional information as shown in block 540.

Security component 130 may submit enrollment information to assertion provider 160. In some embodiments, enrollment information may be submitted to relying party 140, or relying party 140 may already have the enrollment information as described above, and relying party 140 may forward the enrollment information directly (e.g., through a back-channel) to assertion provider 160. Assertion provider 160 may require enrollment information prior to providing authentication services to the user of Internet-enabled application 120.

After successful enrollment, assertion provider 160 may return a go-ahead indicator and an assertion to indicate the user provided all the needed information, as shown in block 560. Component 130 may copy policy file information (e.g., including card information) to secure store 210, as shown in block 570. Component 130 may forward the assertion token to relying party 140, as shown in block 580. Relying party 140 may receive the assertion token and grant access to network-enabled application 120.

### Authentication Workflow

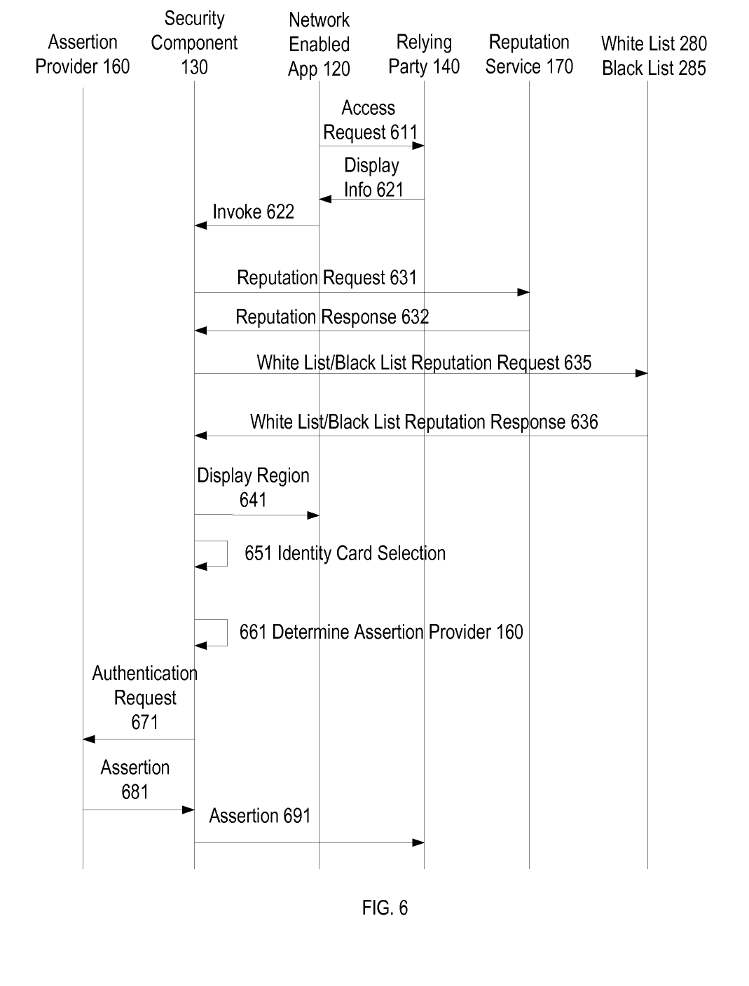

FIG. 6 is a sequence diagram illustrating a security component 130 authenticating a user's credentials and routing an assertion token from an assertion provider 160 to a relying party 140, according to some embodiments. Network-enabled application 120 may attempt to access restricted content (item 611) at relying party 140. Relying party 140 may attempt to gain access to an assertion token (e.g., in the form of a cookie). If the assertion token is available (e.g., cached) and valid (e.g., not expired) access may be granted. If the assertion token is not available, relying party 140 may return (item 621) display information (e.g., web page), invoke security component 130 (item 622) and provide access to an authentication policy file.

Security component 130 may determine the reputation of relying party 140. Security component 130 may retrieve the address of a reputation service 170 from secure store 210 and send a request (item 631) to the reputation service 170 requesting information about the reputation of relying party 140. In some cases a remote reputation service 170 may be accessed via network 150. In other cases a local reputation service 170 may be accessed on client 110. Reputation service 170 may return reputation information (item 632).

In addition, in some embodiments component 130 may check whether the URI of relying party 140 is in white list 480 or black list 485, as shown at items 635 and 636. If the URI exists in the white list, the reputation information is considered reputable and if the URI is on the black list, the reputation information is considered un-reputable.

In some embodiments, in the case where reputation service 170 has no information about relying party 140 and relying party 140 is not identified on the white list or black list, component 130 may allow authentication with assertion providers 160 that are included in cards 215 located in secure store 210. In another case, a card-add-on may be used to access relying party 140. The card-add-on may not share secrets with relying party 140, but may be allowed to share information utilizing zero knowledge proof protocols.

Component 130 may receive identity card selection information from the user (item 65 1). Identity card selection information may include the identity with which the user wishes to use in order to authenticate with assertion provider 160. Security component 130 may determine the assertion provider 160 and access protocol to use in order to authenticate the selected identity (item 661). The assertion provider 160 and protocols used for authentication and communication may be retrieved from secure store 210. Examples of authentication protocols include SSL/TLS with client certificates, ArcotID, HTML-Form, HTTP-Basic/Digest, OpenID and Bearer cookies. Other authentication protocols are possible. Component 130 may send an authentication request (item 671) to assertion provider 160. After successful authentication, assertion provider 160 may produce an assertion token, indicating successful authentication of the user's credentials. In some embodiments, the assertion token may include information other than, or in addition to, user authentication information. For example, the assertion token may include user attributes or payment information. If assertion provider 160 does not authenticate the user, it may return an error message to security component 130.

If the user's credentials are successfully authenticated, assertion provider 160 may send the assertion token back to security component 130 via secure channel, as shown at item 681. In some embodiments, steps 671 and 681 may be repeated multiple times. For example, step 681 may return an error and ask for the user's password again and component 130 may respond with the user's password. In another example, assertion provider 160 may return a response requesting component 130 to authenticate with a different authentication protocol and component 130 may respond using the specified protocol.

Security component 130 may then forward the assertion token to network-enabled application 120, which may forward the assertion token to relying party 140 as shown at items 691. In some embodiments, security component 130 may sign the assertion token according to information included in secure store 210. For example, security component 130 may sign the assertion token with authentication ID 240 or with a private key included in the assertion token received from assertion provider 160. In some cases, shipping information (e.g., name, and shipping address) may be sent with the assertion token to relying party 140 so that the user does not have to enter this information.

In another embodiment, after assertion provider 160 authenticates the user's credentials and creates the assertion token, assertion provider 160 may pass the assertion token directly to relying party 140 through a back-channel, bypassing client system 110 altogether. In this case, assertion provider 160 may pass a reference (e.g., uniform resource identifier) to relying party 140 and relying party 140 may access the assertion token by using the reference. In the case where assertion provider 160 and relying party 140 are the same entity, there may be no need to pass the assertion token. However, relying party 140 must be notified by assertion provider 160 to proceed with granting access to restricted content network enabled application 120.

In another embodiment, assertion provider 160 may be a different entity than relying party 140, but both parties may be configured to exchange assertion tokens directly through a back-channel, bypassing client system 110.

In another embodiment, assertion provider 160 may send an assertion token reference to relying party 140 (e.g., routed through client system 110 or sent directly from assertion provider 160 to relying party 140) and relying party 140 may access the assertion token value on relying party 160 by using the reference.

### The Display Implementation

FIG. 7 is a screen illustration of a network-enabled application 120 with a security component 130 generated embedded region, according to some embodiments. FIG. 7 depicts one example of how network-enabled application 120 may be implemented. Other implementations are possible, including different controls, colors, borders and menus, as well as different positions of the items depicted.

Network-enabled application 120 may draw a window and display a document (e.g., web page) as shown at item 700. The document may comprise display information received from relying party 140. In the example shown in FIG. 7, the display information is received from FictitiousRetailer.com. Component 130 may initiate the display of an embedded region within the window drawn by network-enabled application 120 as shown at item 740. The embedded region 740 may not be a separate window or separate dialog box, but rather may be a displayed rectangle region or another shape drawn within an existing window of network-enabled application 120. In some embodiments, the embedded region 740 may be included within a web page, created by a web page author. The web page author may have included a security component 130 control or reference within the web page when the web page was designed. When the web page is downloaded and received by network-enabled application 120, network-enabled application 120 may invoke security component 130, which may draw the embedded region 740.

In some embodiments, security component 130 may include one or more controls for the user to: (1) turn off reputation service queries, (2) allow queries to be cached, and/or (3) override queries for certain sites.

In the example shown in FIG. 7, the relying party 140 is FictitiousRetailer.com. If the relying party 140 is determined to be reputable, security component 130 may access secure store 210 and search for cards based on filter information received from FictitiousRetailer.com. If one or more cards are found, they may be displayed within embedded region 740, along with customization information defined by the user. In the example shown in FIG. 7, a card is found for the assertion provider 160 called FictitiousBank.com, shown at item 220.

At least a portion of the appearance of the embedded region of the window is defined according to the customization information and not by the relying party. If more than one card is found, the additional cards may also be displayed. A slider control, card selector or scroll bar control (item 760) may be used to scroll through all available cards. In some embodiments, an icon or text identifying assertion provider 160 may be displayed in item 220. This information may have been received from assertion provider 160 when the card information was provisioned.

In various embodiments, a user associated with client system 110 may customize the appearance of embedded region 740 by designating appearance settings of the embedded region 740. The user-customized appearance of embedded region 740 may be displayed by security component 130 in order to make it difficult for an attacker to spoof the appearance of the document displayed by network-enabled application 120. In some cases the user may designate graphic images (e.g., item 710) to be displayed within embedded region 740. Other possible settings include colors, borders, border widths, background colors and background images. In various embodiments, security component 130, network-enabled application 120 or another application of client system 110 may provide a customization program, or some other means for the user of client system 110 to customize the appearance of embedded region 740. The user may customize the appearance of embedded region 740 once or may update the appearance whenever desired. The customization settings 250 may be saved in a secure storage area (e.g., secure store 210).

In some embodiments, the reputation information received from reputation service 170 may indicate the relying party 140 is reputable and security component 130 may display an indication as such. For example, item 770 may be displayed by security component 130 to indicate that FictitousRetailer.com is a reputable relying party 140. The display of the card information 220, item 770 and the other information displayed in item 740 indicates the relying party is reputable. In some embodiments, an icon or logo of the reputation service 170 may be displayed within embedded region 740. When the user mouse-over the icon, information may be displayed about the reputation information (e.g., the reputation rating of the relying party 140).

In some embodiments, the displayed embedded region 740 may display a list of one or more reputation services 170 and allow a user to select the reputation service to query for information about relying party 140 (e.g., FictitiousRetailer.com).

In some embodiments, assertion provider 160 may require the user associated with client system 110 to enter information for authentication purposes. In the example shown in FIG. 7, FictitiousBank.com requires the user to enter a password at item 750 and press the “Log On” button at item 730. In various cases, other information may be requested or no information may be requested.

In some embodiments, the entire screen (other than embedded region 740) may be grayed-out when the user is interacting with the embedded region 740. In the example shown in FIG. 7, embedded region 740 may be shown normally while the rest of the screen may be grayed out. In some cases, item 740 (displayed by security component 130) may be the top window and other applications may be disabled from copying or obscuring the embedded region 740. Other techniques may be used to prevent copying or obscuring embedded region 740.

### Computing Device

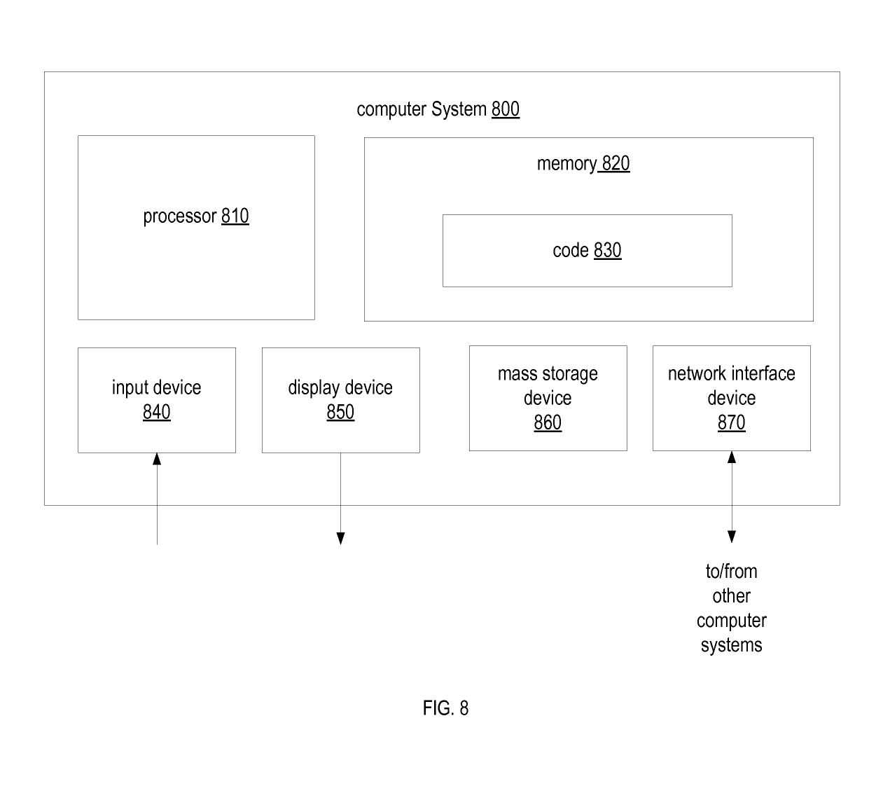

FIG. 8 is a block diagram illustrating a computing device, according to an embodiment. Various security components of embodiments of the network-enabled application 120, security component 130, relying parties 140, assertion providers 160, clients 110 and nodes, etc., as described herein, may be executed on one or more computer systems, which may interact with various other devices. One such computer system is illustrated by FIG. 8. In the illustrated embodiment, computer system 800 includes one or more processors 810 coupled to a system memory 820. Computer system 800 further includes a network interface 870 and one or more input/output devices 840/850, such as a cursor control device, keyboard, audio device and display device 850. In some embodiments, it is contemplated that embodiments may be implemented using a single instance of computer system 800, while in other embodiments multiple such systems, or multiple nodes making up computer system 800, may be configured to host different portions or instances of embodiments. For example, in one embodiment some elements may be implemented via one or more nodes of computer system 800 that are distinct from those nodes implementing other elements.

In various embodiments, computer system 800 may be a uniprocessor system including one processor 810, or a multiprocessor system including several processors 810 (e.g., two, four, eight, or another suitable number). Processors 810 may be any suitable processor capable of executing instructions. For example, in various embodiments, processors 810 may be general-purpose or embedded processors implementing any of a variety of instruction set architectures (ISAs), such as the x86, PowerPC, Scalable Processor Architecture (SPARC), or Million Instructions per Second (MIPS) Instruction Set Architectures (ISAs), or any other suitable ISA. In multiprocessor systems, each of processors 410 may commonly, but not necessarily, implement the same ISA.

System memory 820 may be configured to store program instructions 830 and/or data accessible by processor 810. In various embodiments, system memory 820 may be implemented using any suitable memory technology, such as static random access memory (SRAM), synchronous dynamic RAM (SDRAM), nonvolatile/Flash-type memory, or any other type of memory. Program instructions and/or data may also be stored, for example, on a hard disk. In the illustrated embodiment, program instructions and data implementing desired functions, such as those described above for security component 130, are shown stored within system memory 820 as program instructions 830 and data storage 860, respectively. In other embodiments, program instructions and/or data may be received, sent or stored upon different types of computer-accessible media or on similar media separate from system memory 820 or computer system 800. Generally speaking, a computer-accessible medium may include storage media or memory media such as magnetic or optical media, e.g., disk or Digital Versatile Disc (DVD) Read Only Memory (ROM)/Compact Disk-Read Only Memory (CD-ROM) coupled to computer system 800. Program instructions and data stored via a computer-accessible medium may be transmitted by transmission media or signals such as electrical, electromagnetic, or digital signals, which may be provided via a communication medium such as a network and/or a wireless link, such as may be implemented via network interface 870.

Network interface 870 may be configured to allow data to be exchanged between computer system 800 and other devices attached to a network, such as other computer systems, or between nodes of computer system 800. In various embodiments, network interface 870 may support communication via wired or wireless general data networks, such as any suitable type of Ethernet network, for example; via telecommunications/telephony networks such as analog voice networks or digital fiber communications networks; via storage area networks such as Fibre Channel Storage Area Networks (SANs), or via any other suitable type of network and/or protocol.

Input/output devices 840 and 850 respectively, may in some embodiments include one or more display terminals, keyboards, keypads, touchpads, scanning devices, voice or optical recognition devices, or any other devices suitable for entering or retrieving data by one or more computer system 800. Multiple input/output devices 840 and 850 may be present in computer system 800 or may be distributed on various nodes of computer system 800. In some embodiments, similar input/output devices may be separate from computer system 800 and may interact with one or more nodes of computer system 800 through a wired or wireless connection, such as over network interface 870.

Memory 820 may include program instructions 830, configured to implement at least a portion of embodiments of the security component 130 as described herein, and data storage 860, comprising various documents, tables, databases, etc. accessible by program instructions 830. In one embodiment, program instructions 830 may include software elements of the security component 130 illustrated in the Figures, and data storage 860 may include data used in embodiments of security component 130. In other embodiments, different software elements and data may be included. Program instructions and/or data may be stored, for example, on various types of memory including hard disks.

Those skilled in the art will appreciate that computer system 800 is merely illustrative and is not intended to limit the scope of the security component 130 as described herein. In particular, the computer system and devices may include any combination of hardware or software that can perform the indicated functions, including computers, network devices, internet appliances, PDAs, mobile phones, pagers, etc. Computer system 800 may also be connected to other devices that are not illustrated, or instead may operate as a stand-alone system. In addition, the functionality provided by the illustrated security component 130 may in some embodiments be combined in fewer security components 130 or distributed in additional security components 130. Similarly, in some embodiments, the functionality of some of the illustrated security components 130 may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software security components 130 may execute in memory on another device and communicate with the illustrated computer system via inter-computer communication. Some or all of the security component 130 or data structures may also be stored (e.g., as instructions or structured data) on a computer-accessible medium or a portable article to be read by an appropriate drive, various examples of which are described above. In some embodiments, instructions stored on a computer-accessible medium separate from computer system 800 may be transmitted to computer system 800 via transmission media or signals such as electrical, electromagnetic, or digital signals, provided via a communication medium such as a network and/or a wireless link. Various embodiments may further include receiving, sending or storing instructions and/or data implemented in accordance with the foregoing description upon a computer-accessible medium. Accordingly, the present invention may be practiced with other computer system configurations.

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g. Synchronous Dynamic RAM (SDRAM), Double Data Rate RAM (DDR RAM), RAMBUS Dynamic RAM (RDRAM), Static RAM (SRAM), etc.), Read Only Memory (ROM), etc. as well as transmission media or signals such as electrical, electromagnetic, or digital signals, provided via a communication medium such as network and/or a wireless link.

The various methods as illustrated in the Figures and described herein represent exemplary embodiments of methods. The methods may be implemented in software, hardware, or a combination thereof. The order of method may be changed, and various elements may be added, reordered, combined, omitted, modified, etc.

Various modifications and changes may be made as would be obvious to a person skilled in the art having the benefit of this disclosure. It is intended that the invention embrace all such modifications and changes and, accordingly, the above description to be regarded in an illustrative rather than a restrictive sense.

1. A computer-implemented method, comprising:
a client-side security component accessing, from a local store, appearance information describing at least part of an appearance for an embedded region;
the client-side security component displaying the embedded region in an indicated area within a window drawn by a network-enabled application,
wherein the window is drawn according to display information received from a relying party,
wherein the display information from the relying party indicates the area within the window where the embedded region is to be drawn, and
wherein said displaying comprises:
displaying the embedded region as an integral part of the window drawn by the network-enabled application; and
displaying at least part of the appearance of the embedded region according to the locally accessed appearance information and not according to the relying party;
the client-side security component sending a request to a reputation service for reputation information about the relying party;
the client-side security component receiving reputation information from the reputation service; and
the client-side security component displaying an indication of the relying party's reputation in the embedded region according to the reputation information received from the reputation service.

2. The computer-implemented method of claim 1, further comprising, in response to receiving reputation information from the reputation service indicating the relying party is not reputable, the client-side security component preventing the network- enabled application from sending information to the relying party.

3. The computer-implemented method of claim 1, further comprising:
wherein the reputation service is a remote reputation service located on a server accessible via a network connection; and
the client-side security component receiving the reputation information from the remote reputation service via said network connection.

4. The computer-implemented method of claim 3, further comprising:
the client-side security component caching reputation information received from the remote reputation service; and
subsequently, prior to sending a request to the remote reputation service:
the client-side security component searching the cached reputation information to determine the reputation of the relying party; and
the client-side security component using the cached reputation information rather than sending a request to the reputation service.

5. The computer-implemented method of claim 1, wherein the reputation service is a local reputation service, wherein said local reputation service resides on the same client system as said client-side security component.

6. The computer-implemented method of claim 1, further comprising:
the client-side security component downloading reputation information about a plurality of relying parties from a remote reputation service;
the client-side security component maintaining a local cache of the downloaded reputation information about the plurality of relying parties; and
subsequently, the client-side security component searching the local cache to determine reputation information for one of the relying parties;
in response to finding the reputation information for one of the relying parties in the local cache, the client-side security component utilizing the reputation information from the local cache rather than sending a request to the reputation service.

7. The computer implemented method of claim 1, further comprising:
the client-side security component searching a white list for an address corresponding to said relying party, wherein said white list comprises a list of addresses corresponding to a respective plurality of reputable relying parties; or
the client-side security component searching a black list for the address corresponding to the relying party, wherein said black list comprises a list of addresses corresponding to a respective plurality of non-reputable relying parties; and
the client-side security component displaying an indication of the relying party's reputation within the embedded region according to the whether or not the address corresponding to the relying party is found in the white list or in the black list.

8. The computer-implemented method of claim 7, further comprising, in response to not finding the address of the relying party on the white list, the client-side security component preventing the network-enabled application from sending information to the relying party.

9. The computer implemented method of claim 7, further comprising, the client-side security component maintaining said white list or said black list locally on the same system as the client-side security component.

10. The computer implemented method of claim 7, further comprising the client-side security component maintaining said white list or said black list on a remote server accessible via a network connection.

11. The computer implemented method of claim 10, further comprising the client-side security component periodically or aperiodically downloading said white list or said black list to be accessed locally.

12. The computer implemented method of claim 7, further comprising the client-side security component administering said white list or said black list according to user input.

13. A system, comprising:
one or more processors;
a memory coupled to the one or more processors, wherein the memory stores program instructions for a client-side security component, wherein when the program instructions for the client-side security component are executed by the one or more processors, the one or more processors perform:
accessing, from a local store, appearance information describing at least part of an appearance for an embedded region;
initiating the display of displaying the embedded region in an indicated area within a window drawn by a network-enabled application,
wherein the window is drawn according to display information received from a relying party,
wherein the display information from the relying party indicates the area within the window where the embedded region is to be drawn, and
wherein said displaying comprises:
displaying the embedded region as an integral part of the window drawn by the network-enabled application; and
displaying at least part of the appearance of the embedded region according to the locally accessed appearance information and not according to the relying party;
sending a request to a reputation service for reputation information about the relying party;
receiving reputation information from the reputation service; and
displaying an indication of the relying party's reputation in the embedded region according to the reputation information received from the reputation service.

14. The system as recited in claim 13, wherein when the program instructions are executed, the one or more processors further perform, in response to receiving reputation information from the reputation service indicating the relying party is not reputable, preventing the network-enabled application from sending information to the relying party.

15. The system as recited in claim 13, wherein when the program instructions are executed, the one or more processors further perform, receiving the reputation information from a remote reputation service via a network connection.

16. The system as recited in claim 15, wherein when the program instructions are executed, the one or more processors further perform:
caching reputation information received from the remote reputation service; and
subsequently, prior to sending a request to the remote reputation service:
searching the cached reputation information to determine the reputation of the relying party; and
using the cached reputation information rather than sending a request to the remote reputation service.

17. The system as recited in claim 13, wherein said reputation service resides on the same client system as said client-side security component.

18. The system as recited in claim 13, wherein when the program instructions are executed, the one or more processors the client side security component further perform:
downloading reputation information about a plurality of relying parties from a remote reputation service;
maintaining a local cache of the downloaded reputation information about the plurality of relying parties; and
subsequently, searching the local cache to determine reputation information for one of the relying parties;
in response to finding the reputation information for one of the relying parties in the local cache, utilizing the reputation information from the local cache rather than sending a request to the reputation service.

19. The system as recited in claim 13, wherein when the program instructions are executed, the one or more processors further perform:
searching a white list for an address corresponding to said relying party, wherein said white list comprises a list of addresses corresponding to a respective plurality of reputable relying parties; or
searching a black list for the address corresponding to the relying party, wherein said black list comprises a list of addresses corresponding to a respective plurality of non-reputable relying parties; and
displaying an indication of the relying party's reputation on the display of the embedded region according to the whether or not the address corresponding to the relying party is found in the white list or in the black list.

20.-24. (canceled)

25. A non-transitory computer-accessible storage medium storing program instructions, wherein the program instructions are computer-executable to implement a client-side security component, wherein when the program instructions for the client-side security component are executed, the program instructions execute on a computer to perform:
accessing, from a local store, appearance information describing at least part of an appearance for an embedded region;
displaying the embedded region in an indicated area within a window drawn by a network-enabled application,
wherein the window is drawn according to display information received from a relying party,
wherein the display information from the relying party indicates the area within the window where the embedded region is to be drawn, and
wherein said displaying comprises:
displaying the embedded region as an integral part of the window drawn by the network-enabled application; and
displaying at least part of the appearance of the embedded region according to the locally accessed appearance information and not according to the relying party;
sending a request to a reputation service for reputation information about the relying party;
receiving reputation information from the reputation service; and
displaying an indication of the relying party's reputation in the embedded region according to the reputation information received from the reputation service.

26. The non-transitory computer-accessible storage medium as recited in claim 25, wherein when the program instructions are executed, the program instructions execute on the computer to further perform, in response to receiving reputation information from the reputation service indicating the relying party is not reputable, preventing the network- enabled application from sending information to the relying party.

27. The non-transitory computer-accessible storage medium as recited in claim 25, wherein when the program instructions are executed, the program instructions execute on the computer to further perform, receiving the reputation information from a remote reputation service via a network connection.

28. The non-transitory computer-accessible storage medium as recited in claim 27, wherein when the program instructions are executed, the program instructions execute on the computer to further perform:
caching reputation information received from the remote reputation service; and
subsequently, prior to sending a request to the remote reputation service:
searching the cached reputation information to determine the reputation of the relying party; and
using the cached reputation information rather than sending a request to the remote reputation service.

29. The non-transitory computer-accessible storage medium as recited in claim 25, wherein said reputation service resides on the same client system as said client-side security component.

30. The non-transitory computer-accessible storage medium as recited in claim 25, wherein when the program instructions are executed, the program instructions execute on the computer to further perform:
downloading reputation information about a plurality of relying parties from a remote reputation service;
maintaining a local cache of the downloaded reputation information about the plurality of relying parties; and
subsequently, searching the local cache to determine reputation information for one of the relying parties;
in response to finding the reputation information for one of the relying parties in the local cache, utilizing the reputation information from the local cache rather than sending a request to the reputation service.

31. The non-transitory computer-accessible storage medium as recited in claim 25, wherein when the program instructions are executed, the program instructions execute on the computer to further perform:
searching a white list for an address corresponding to said relying party, wherein said white list comprises a list of addresses corresponding to a respective plurality of reputable relying parties; or
searching a black list for the address corresponding to the relying party, wherein said black list comprises a list of addresses corresponding to a respective plurality of non-reputable relying parties; and
displaying an indication of the relying party's reputation on the display of the embedded region according to the whether or not the address corresponding to the relying party is found in the white list or in the black list.

32. The non-transitory computer-accessible storage medium as recited in claim 31, wherein when the program instructions are executed, the program instructions execute on the computer to further perform, in response to not finding the address of the relying party on the white list, preventing the network-enabled application from sending information to the relying party.

33. The non-transitory The computer-accessible storage medium as recited in claim 31, wherein when the program instructions are executed, the program instructions execute on the computer to further perform, maintaining said white list or said black list locally on the same system as the client-side security component.

34. The non-transitory computer-accessible storage medium as recited in claim 31, wherein when the program instructions are executed, the program instructions execute on the computer to further perform, maintaining said white list or said black list on a remote server accessible via a network connection.

35. The non-transitory computer-accessible storage medium as recited in claim 33, wherein when the program instructions are executed, the program instructions execute on the computer to further perform, periodically or aperiodically downloading said white list or said black list to be accessed locally.

36. The non-transitory computer-accessible storage medium as recited in claim 31, wherein when the program instructions are executed, the program instructions execute on the computer to further perform, administering said white list or said black list according to user input.

37. A computer-implemented method, comprising:
a client-side security component accessing, from a local store, appearance information describing at least part of an appearance for an embedded region;
the client-side security component displaying the embedded region in an indicated area within an interface drawn by a network-enabled application,
wherein the interface is drawn according to display information received from a relying party,
wherein the display information from the relying party indicates the area within the interface where the embedded region is to be drawn, and
wherein said displaying comprises:
displaying a user interface element for accepting data within the embedded region;
displaying the embedded region as an integral part of the interface drawn by the network-enabled application; and
displaying at least part of the appearance of the embedded region according to the locally accessed appearance information and not according to the relying party;
the client-side security component, through the user interface element within the embedded region, receiving data indicating a reputation service;
the client-side security component sending a request to the reputation service for reputation information about the relying party;
the client-side security component receiving reputation information from the reputation service; and
the client-side security component displaying an indication of the relying party's reputation in the embedded region according to the reputation information received from the reputation service.

38. The computer-implemented method of claim 37, wherein the display of the embedded region is drawn within the interface as part of the display information received from the relying party.

39. The computer-implemented method of claim 37, further comprising:
displaying a second user interface element displaying for one or more selectable options.

40. The computer-implemented method of claim 39, further comprising:
redrawing the display information received from the relying party while a user is interacting with the user interface element,
wherein the redrawing de-emphasizes the display information received from the relying party in contrast to the embedded region.

41. The computer-implemented method of claim 39,
wherein one option of the one or more selectable options allows a user to select the reputation service.

42. (canceled)

43. The computer-implemented method of claim 1, further comprising:
the client-side security component displaying, within the embedded region, a user interface element for accepting user data;
the client-side security component, through the user interface element within the embedded region, receiving data indicating a security-related option; and
the client-side security component, through the user interface element within the embedded region, displaying security or privacy information in response to said receiving data indicating the security-related option.
